(19) United States
(12) Patent Application Publication
(10) Pub. No.: US 2007/0192206 A1
(43) Pub. Date: Aug. 16, 2007

(54) Product evaluation system enabling Internet shopping through various portals using various mobile devices

(76) Inventors: Nasser K. Manesh, Costa Mesa, CA (US); Saied Kazemi, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 11/545,161

(22) Filed: Oct. 10, 2006

Related U.S. Application Data
(60) Provisional application No. 60/772,249, filed on Feb. 10, 2006.

(51) Int. Cl. G06Q 30/00

(52) U.S. Cl. 705/26

(57) ABSTRACT

A product evaluation system for permitting a consumer to obtain information about an item of interest. The system includes a core engine processor and an item pricing module. The core engine processor is capable of receiving a communication from the consumer's mobile phone. The core engine processor constructs a query for the item of interest. The item pricing module obtains at least price information for the item of interest by querying at least one Internet site. The obtained information may be conveyed to the consumer by voice, text message, and/or later access via the Internet. The item of interest may be identified by the consumer submitting bar code indicia or by answering a series of questions posed by the system. Further, the consumer may submit additional information in regard to the item of interest which will be stored by the core engine processor and is capable of later being retrieved by the consumer. In particular, the additional information as well as the information obtained by the product evaluation system may be conveyed to the user via a web page.

### CROSS-REFERENCE TO RELATED APPLICATIONS

This application claims the benefit of U.S. Provisional Application No. 60/772,249, filed on Feb. 10, 2006, the teachings of which are expressly incorporated by reference.

### STATEMENT RE: FEDERALLY SPONSORED RESEARCH/DEVELOPMENT

Not Applicable

### BACKGROUND

Consumers are becoming more comfortable with online shopping, and the Internet has created an effective vehicle for shopping for various products and services. Companies that offer products virtually on the Internet can provide competitive prices, usually lower than their physical store location counterparts, because of the lower cost of operation. Also, there are price comparison services on the Internet that collect and present prices for the same item to consumers, allowing the consumers to choose the best match.

In addition, the proliferation of mobile phones has created a new lifestyle for consumers. Consumers have grown accustomed to using mobile phones anywhere they go. In many cases, users can receive emails on their mobile phones, and this brings more flexibility and mobility to their lives. In accordance with this trend, many companies have attempted to make mobile phones Internet-enabled to allow their customers to access the Internet to get the information they need anytime, anywhere. However, using a mobile phone as a replacement for a personal computer, for example, to do any kind of comprehensive Internet searching can be extremely cumbersome and thus has not been well adopted by consumers. There is a vast amount of information that consumers could use while away from their homes or offices, but unfortunately the inherent limitations of using a mobile phone as an Internet access point presents a challenge to consumers who want to access that body of information.

Additionally, accessing the Internet from a user's mobile phone requires a special phone that is capable of accessing the Internet as well as a data service plan offered by the user's mobile phone company. These mobile phones that are capable of accessing the Internet are usually more expensive than traditional mobile phones and are often difficult to operate, especially by non-tech savvy users. Furthermore, the data service plans offered by mobile phone companies can be expensive, thereby eliminating potential users who do not wish to pay an extra monthly fee for Internet access. Many potential solutions have been offered for creating ease of use in accessing information from the Internet using a mobile phone; however, all of these previous solutions still have the drawback of requiring costly and complicated Internet-accessible phones and sometimes expensive data service plans.

For example, U.S. Pat. No. 6,430,554, filed on Jan. 25, 2000 and issued to Rothschild on Aug. 6, 2002 discloses a method of receiving information relating to a desired product by inputting the product's Universal Product Code (UPC) into a desktop computer, a Portable Digital Assistant (PDA), or a phone having access to the Internet. The inputted information is then transmitted to a server which obtains the data. This patent mentions that software to utilize the process may be installed on the user's portable computer and/or that a PDA having a bar code scanner may be used.

U.S. Pat. No. 6,651,053, filed on Aug. 28, 2000 and issued to Rothschild on Nov. 18, 2003 discloses a method of obtaining information relating to a desired product by inputting or scanning a UPC code into a desktop computer, Internet-enabled PDA, or a wireless Internet accessible phone. Relevant information is then received via the user's web browser and can further be transferred to other devices.

U.S. Pat. No. 6,766,363, filed on Aug. 31, 2000 and issued to Rothschild on Jul. 20, 2004 discloses a method of obtaining information related to a content item of interest while observing a visual, audio, or printed medium containing the item. This is achieved by entering enough information to identify the medium and the interesting item contained in the medium into a home computer, Internet-enabled PDA, or Internet-enabled phone.

U.S. Pat. No. 6,993,573, filed on Jun. 7, 2004 and issued to Hunter on Jan. 31, 2006 discloses a system for retrieving information regarding an item utilizing a cellular phone having a camera and Internet-connectivity. The camera is able to take a picture of the barcode on the item, transmit it over the wireless Internet, and receive information regarding the item via the phone's web browser.

What are needed, therefore, are enhanced methods and systems for permitting consumers to obtain product information and/or to purchase products on the Internet by utilizing easy to use access devices such as standard mobile phones without requiring the use of expensive and/or confusing Internet-accessible devices.

### BRIEF SUMMARY

One embodiment of the present invention contemplates a product evaluation system for permitting a consumer to obtain information about an item of interest. The system includes a core engine processor, an item pricing module, and an item purchasing module. The core engine processor is capable of receiving a communication from an access device of the consumer through at least one communication portal. The information communicated from the access device includes at least bar code indicia associated with the item of interest. The core engine processor is further capable of constructing a query for the item of interest based at least in part on the communicated bar code indicia. The item pricing module is operatively associated with the core engine processor, and is capable of querying at least one Internet site with the core engine processor's query to obtain at least price information for the item of interest. The item purchasing module is operatively associated with the core engine processor, and is capable of executing one or more purchase orders in association with the item of interest. The communication portal may include a voice portal capable of receiving information from a mobile phone access device.

Another embodiment of the invention contemplates a method for registering a consumer to access a system for permitting the consumer to obtain information about an item of interest. The method includes creating in the system a registration object including a random validation code. This registration object is associated with a mobile phone number of the consumer. The random validation code in the registration object is then emailed to the consumer. A consumer-supplied random validation code is then received through a voice portal of the system. Finally, the consumer-supplied random validation code received through the voice portal is compared to the random validation code included in the registration object. The method may further include registering the consumer with the system if the consumer-supplied random validation code received through the voice portal matches the random validation code included in the registration object.

Yet another embodiment of the present invention contemplates a product evaluation system for permitting a consumer to obtain information about an item of interest. The system includes a core engine processor and an item pricing module. The core engine processor is capable of receiving a communication from the consumer's mobile phone through a voice portal. The information communicated from the mobile phone is used to identify the item of interest. The core engine processor is also capable of constructing a query for the item of interest based at least in part on the communicated identifying information. The item pricing module is operatively associated with the core engine processor, and is capable of obtaining at least price information for the item of interest by querying at least one Internet site with the query constructed by the core engine processor.

The system may further include an item purchasing module operatively associated with the core engine processor, and capable of executing one or more purchase orders in association with the item of interest. The information communicated may be bar code indicia associated with the item of interest. The information communicated may also be the answers to a series of questions posed by the core engine.

The system may further include at least one additional communication portal. These additional portals may include an SMS portal and/or a web portal. The voice portal may be accessed by the consumer telephoning the voice portal.

Upon obtaining at least the price information, the core engine may receive additional information from consumer regarding the item of interest. This additional information may be a bookmark, a voice note, and/or a desired price of the item of interest. If a desired price of the item of interest is submitted by the consumer, the item pricing module may monitor the price of the item of interest on at least one Internet site. The item pricing module may also convey any price information from an Internet site equal to or less than the desired price to the consumer via at least one communication portal. The additional information may also be accessed by the consumer via one of the communication portals. In particular, the additional information may be accessed via the web portal, wherein all of the additional information submitted by the user, as well as the information obtained by Frucall, may be communicated to the user in one cohesive presentation.

The price information may be obtained from an online retail site, a price aggregator, and/or a store website, wherein the store is located within the vicinity of the consumer. The price information obtained may be conveyed to the consumer via the SMS portal.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 schematically depicts an example of a product evaluation system that can be provided in accordance with various embodiments of the invention;

FIG. 2 illustrates examples of the interaction of a product evaluation system in accordance with embodiments of the invention implemented in association with various external entities;

FIG. 3 includes a flow chart that illustrates an example of consumer interaction with a voice portal of a product evaluation system configured in accordance with embodiments of the invention; and,

FIG. 4 includes a flow chart demonstrating samples of user dialog that can be enabled with a product evaluation system configured in accordance with various embodiments of the invention.

### DETAILED DESCRIPTION

In various embodiments, the invention provides a mobile shopping system, with the capability of online or Internet shopping directly from a mobile phone or cell phone through a consumer making phone calls to a product evaluation system. Shopping may be performed and accomplished by consumers without the need to be connected to the Internet or to have a data service from a mobile carrier. Embodiments of the invention permit consumers to call in to a product evaluation system, specify what product or item they are interested in by using voice or touch tone (e.g., Dual Tone Multi Frequency), for example. The product evaluation system may employ an automated process through various Internet web services to search for online prices, for example, for products of interest to the consumer, and then communicate the price information back to the consumer. Users can purchase the product or item, bookmark items for later viewing from a personal computer, leave themselves voice notes about the item, listen to ratings and reviews, and/or perform other product or shopping related actions. In various embodiments, the invention provides a new way of online shopping by combining and leveraging different technologies. For example, embodiments of the product evaluation system may represent an aggregation of telephony applications, interactive voice response (“IVR”) systems, Internet-based service-oriented architecture (“SOA”) data access, web-based applications, and/or shopping systems.

Embodiments of the invention can address the gap between functionality of an access device such as a mobile phone and the broad-based information supplied by the Internet, providing a bridge between the mobile phone and the Internet. In a sense, the mobile phone can be employed as a proxy through the product evaluation system for providing Internet access to the consumer. Using embodiments described herein, consumers can continue to employ the type of interaction to which they are accustomed when using a mobile phone (e.g., dialing numbers, talking and punching digits), and at the same time receive online information from the Internet about items and products of interest.

As applied herein, a “product” may include a product, service, product/service, a purchase item, or any other item of interest to a consumer.

As applied herein, an “access device” may include a mobile phone, cell phone, wireless phone, wireline phone, personal data assistant (PDA), pager, e-mail access device (e.g., a “Blackberry” device), electronic gaming device, or any other device that can be configured for accessing one or more functions or components of a product evaluation system in accordance with various embodiments of the invention.

The term “Frucall” may be employed at various times herein to refer generally to embodiments of a product evaluation system, and its associated functions and processes, as provided in accordance with the invention.

The following is an exemplary scenario for using embodiments of the Frucall system and is provided for purposes of illustrating various aspects of the invention. A consumer is out shopping at a physical store location and sees a product displayed on the store floor. The product may be a CD, a digital camera, a game, or any other product. The consumer calls the Frucall system phone number from his or her cell phone, and enters the universal product code (“UPC code”) or other bar code number identified on the product. The Frucall system receives the UPC code, searches on the Internet through online product services or Internet sites such as Amazon, Froogle, or Yahoo, for example, and provides the consumer with price information for the product. The price information obtained through accessing the Frucall system may include a price for the product which is less than the price of the product offered for sale at the physical store location.

The user can then enter a PIN to ask the Frucall system to purchase the item on behalf of the consumer. The Frucall system may use the CallerID of the access device (which may be a mobile phone, for example) of the consumer to identify the consumer (who may have previously registered on a web portal, for example, associated with the Frucall system); check the PIN of the consumer; and thereby identify the consumer. If the consumer has already registered a credit card with the Frucall system, for example, the system can use the credit card number and shipping/billing address, and complete a purchase of the product for the consumer. If the consumer does not wish to purchase the product, or does not have a registered credit card or other payment means established with the system, the Frucall system can be configured to bookmark the item so that the consumer can review product information at a later time on the Frucall web portal, for example. The consumer may be presented with other options such as, for example, listening to ratings and reviews; finding out used or individually listed prices; leaving voice memos about the item; and/or other functions. The voice memos can be configured to be accessible to the consumer on the web portal.

In various embodiments, the Frucall system allows consumers to do the same above-described activities by using short messaging service (“SMS”), or multimedia message service (“MMS”), such as if the consumer's mobile phone or wireless carrier is capable of sending and receiving text messages or multimedia messages. In this application SMS in general refers to both SMS and MMS since the underlying technologies, as far as Frucall is concerned, are similar. In addition, wireless access protocol (“WAP”) may be employed, for example, if the consumer's access device is equipped with a WAP browser and the wireless carrier provides a WAP gateway. It can be seen that these are optional, alternative methods of accessing the Frucall system which can be made available through various portals provided by the Frucall system.

It can be appreciated that the Frucall system, in various embodiments, can enable consumers to shop online without being online, e.g., when not at a PC and when all they have is a mobile phone. This capability can enable consumers to make better-informed shopping decisions anytime and anywhere the consumers find products of interest.

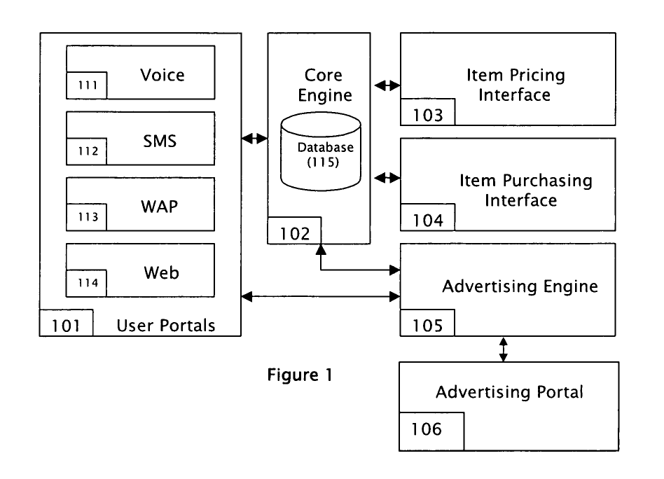

Referring to FIG. 1, in various embodiments, a Frucall product evaluation system may be composed of various subsystems which work cooperatively between/among each other. The subsystems of the product evaluation system may include, for example, User Portals 101, a Core Engine processor 102, an Item Pricing Information Interface module 103, a Purchasing Interface module 104, an Advertisement Engine module 105, and/or an Advertisement Portal 106.

The User Portals 101 include those parts of the system that provide the user interface for consumers to access product information. The user might access the Frucall system using different portals for different purposes. The Voice Portal 111 can be the entry point to the Frucall system by calling a phone number. This portal 111 may provide an IVR using ASR (Automatic Speech Recognition), TTS (Text To Speech) and DTMF (Dual Tone Multi Frequency) to accept user input and communicate output back to the consumer, and allows users to supply bar code numbers and/or product names and models, receive prices, select and buy items, bookmark items, listen to rates and reviews, leave voice memos, and/or perform other functions. The SMS Portal 112 can provide the same price search and shopping capability using text messages sent to/from a mobile phone, for example. In the case of the SMS portal, for example, consumers can store text memos for items they have reviewed and evaluated. The WAP Portal 113 can provide access to the same features through a WAP browser, for example, if the access device of the consumer is equipped with this capability. The Web Portal 114 may be a web-based application that permits consumers to register, save credit card information, view bookmarks, listen to voice memos, and/or perform other functions via a personal computer system, for example. In one embodiment of the present invention, all of the different User Portals 101 are connected to the Core Engine 102 and share the same data about what the user is doing. In particular, the various portals including Voice 111, SMS 112, WAP 113, and Web 114 may interact thereby creating a unified user interface for the consumer. This unified user interface can employ different portals at the same time. For example, a user may call Frucall via the Voice Portal 111, and during the call he or she may request to receive the prices via SMS. Because all of the data is stored in the Core Engine 102, the Voice Portal 111 can interface with Core Engine 102, which then relays the requested data to the SMS portal 112 which sends the information to the user as an SMS message. Another example of the unified user interface is that all of the searches done via any of the portals may be immediately available under a “search history” section of the Web Portal 114. Furthermore, each of the User Portals 101 may store information about items the user is searching for in the Core Engine 102.

The Frucall Core Engine 102 may be a processor and/or computer system that serves as the “brain” of the system to accept inquiries from the User Portal 101, construct a query, and send the constructed query to the Item Pricing Interface 103. The Core Engine 102 may also be configured for storing user information including phone numbers, email addresses, credit card information, billing and shipping addresses, and/or other like information, in an operatively associated database or other storage medium. For example, when a consumer calls in through the Voice Portal 111, or the SMS Portal 112, the Core Engine 102 may use ANI (Automatic Number Identification) to find the caller's phone number, look it up in the database, and find out whether the user is registered or not. If the consumer is already registered, the Core Engine 102 can retrieve consumer credit card and billing information to pass to the Item Purchasing Interface 104 to complete a sales or purchase transaction, for example. Regardless of whether a consumer is registered, the Core Engine 102 can keep track of items that the consumer looks up, and allow the consumer to bookmark the items and/or leave voice notes on them. When the user visits the Web Portal 114, the Web Portal 114 may request a phone number from the consumer. When the consumer submits the phone number, the Web Portal 114 may ask the Core Engine 102 to retrieve any items, bookmarks, voice notes, or other information associated with the phone number and then display the information to the consumer on a personal computer system, for example.

In various embodiments, the Item Pricing Interface 103 can be configured for making automated Web Services API calls to various sources of information on the Internet, such as an online shopping service or entity like Amazon, Yahoo, Google, eBay, and others. The Item Purchasing Interface 104 may serve to place orders with a merchant or online shopping service identified by the Item Pricing Interface 103.

The Advertising Engine 105 may be a processor or computer system responsible for collecting any information that may impact a user's decision about purchasing or not purchasing something, such as user behavior information associated with shopping activity of the consumer or statistical information about popular items, for example. It may also store advertiser information, including brands and merchants that would like to advertise via the Frucall system. Such information, as well as ads supplied by the advertisers in different forms of media (text, audio, multimedia), may be supplied via the Advertisement Portal 106, which in one embodiment is the entry point of Frucall advertisers into the Frucall system. The Advertising Engine 105 may be configured to retrieve advertisements, either automatically from the Internet or from the advertisement media stored by advertisers specifically for Frucall via the Advertisement Portal 106, and/or play/send/display such advertisements for the consumer on the Voice Portal 111, SMS Portal 112, WAP Portal 113, or the Web Portal 114, for example.

The User Portals 101 are the “face” of the system that consumers can communicate with in order to evaluate various products. The Voice 111/SMS 112/WAP 113 Portals can be configured to provide practical, valuable information about individual products or items to the consumer that can result in closing a sales transaction, for example, or saving the information for a later time when the consumer can conveniently access the Internet from a personal computer, for example, and visit the Web Portal 114. The Web Portal 114 can be configured in numerous ways, for example, to show the history of what the user has looked for previously; to display items that the user has had interest in by bookmarking or leaving a voice note; to provide links to reviews and rating information for various products; to provide a ready interface for purchasing the items or products; and/or to display advertisements associated with various products. The Web Portal 114 can also serve as a medium wherein users register, define product preferences, and/or personalize their web and voice portal experience.

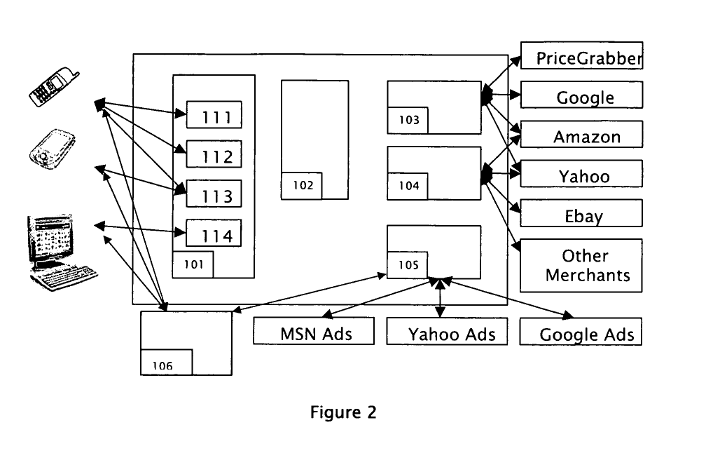

As shown in FIG. 2, user interactions through the portals may result in storing or changing user-specific data stored in the Core Engine 102, or can result in making calls (e.g., API calls) to the Item Pricing Interface 103 to get information from external sources on the Internet and store item-specific data in the Core Engine 102. If a user interaction results in purchasing an item, the Core Engine 102 can make calls to the Item Purchasing Engine 104 to put in an order with the right merchant. In parallel with these functions, the Advertising Engine 105 may use online advertisement systems, as well as advertisement media stored via the Advertisement Portal 106, to prepare related and targeted advertisements and present them to the user. These advertisements may be presented via any of the User Portals 101. When the user is on the Voice Portal 111, making a call to the Frucall system in order to get pricing information about an item, the Voice Portal 111 may ask the Advertisement Engine 105 for targeted ads related to the item. The advertisement can be in the form of text, in which case the Voice Portal 111 may use Text-To-Speech technology to convert it to voice, or could be a pre-recorded advertisement, which will be delivered by the Voice Portal 111 as is. In this example, the result is that the user would hear a related advertisement upon entering the barcode to search for the product. The Voice Portal 111 is also capable of playing sponsored advertisements, which may or may not be related to the product. For example, if the advertisement is not related or targeted, the advertisement may be played during any interaction with the user, for example, right after the user is greeted by the Voice Portal 111. On the SMS portal 112 and WAP Portal 113 a similar situation may occur, wherein the advertisement is delivered to the user in the form of text or multimedia content playable by the user's cell phone. The Web Portal may choose proper related advertisements based on a user's bookmarked items, for example, and display them to the consumer via the Web Portal 114.

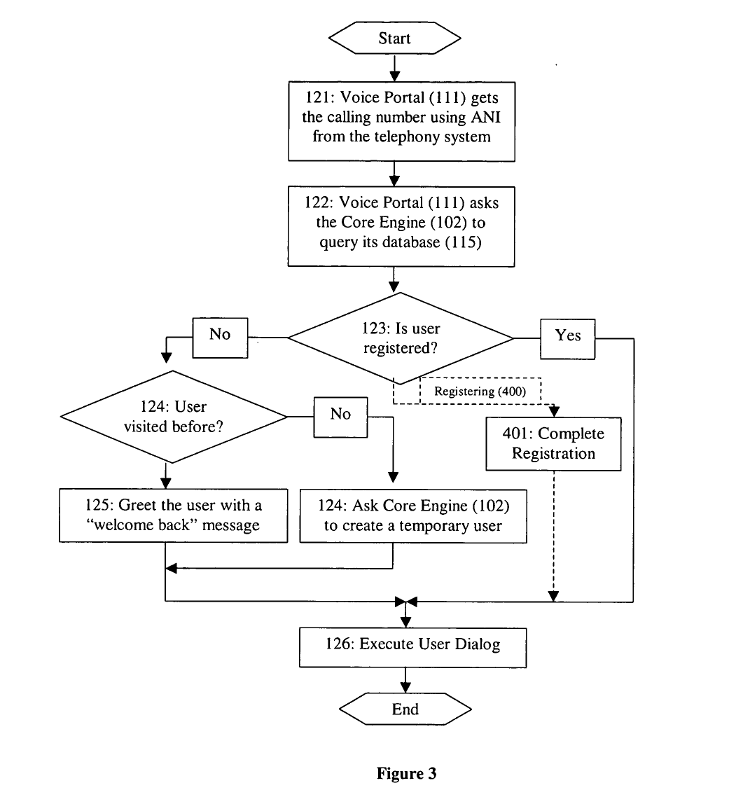

With reference to FIG. 3, a flow chart is shown that illustrates examples of interaction between a consumer and the Voice Portal 111. Step 122, as well as any other interaction between/among the components of the system, can be done by use of standard API calls between/among the components. The Core Engine 102 provides a database 115 for the User Portals 101, thereby permitting multiple portals 111, 112, 113, 114 to access the same data storage through making API calls to the Core Engine 102. The database 115 can be configured to store user profiles, shopping profiles, historical data, and other kinds of information. In the database 115, objects with clear interfaces may wrap tables such as users, items, bookmarks, sales history, and preferences and implement a Create, Read, Update and Delete (“CRUD”) interface for the data using an Active Record pattern, for example.

In step 124, a temporary user can be created by making API calls to the user object in the Core Engine 102. This can create a user record in the database 115 which contains the phone number of the user even though at this point the system may not have any further knowledge of the user's email address, for example, or other profile information. This helps the Frucall system to keep track of bookmarks and search history of consumers until they register on the Web Portal 114 at a later time.

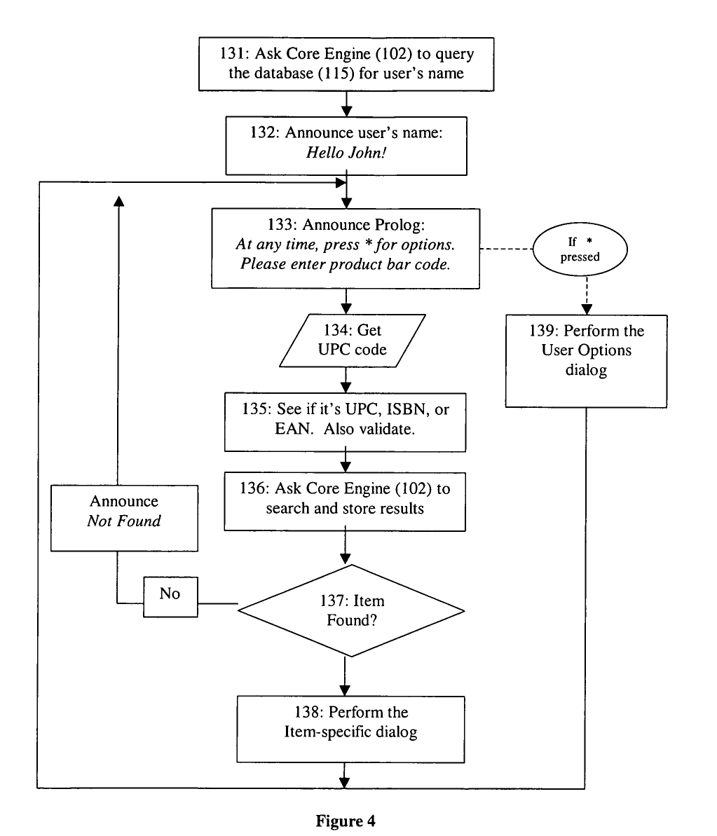

With reference to FIG. 4, once the user record is created for the consumer, the Frucall system can start a dialog with the user. At this point, in one embodiment, the Voice Portal 111 fetches a sponsored advertisement from the Advertisement Engine 105 to play for the user. The Advertisement Engine may use certain factors including the user's search history, the user's phone number, and the user's ZIP code to decide which sponsored advertisement should be played. For example, if the search history of the user shows several sporting goods looked up, a sponsored advertisement from a sporting goods company may be played. Step 135 permits users to identify and use different types of bar code indicia on products, depending on the type of the product being evaluated and how the bar code indicia are used or located on various products. Therefore, the Frucall system can intelligently decide what kind of bar code is being supplied by the consumer and act accordingly. For example, each of UPC, ISBN and EAN coding schemes use a different type of checksum. The Frucall system can be configured to check to see what type of bar code indicia are being received and to validate the bar code indicia to identify products. The submitted bar code may also be used to fetch a relevant advertisement from the Advertisement Engine 105 and play it for the user.

In certain situations a bar code may not be available or identifiable for an item. In these instances, a user may interact with Frucall via Text-To-Speech (TTS) and Automatic Speech Recognition (ASR) systems in order to identify the item. The user is asked increasingly specific questions in order to determine the intended item. One particular embodiment is discussed herein for illustrative purposes, but it is contemplated that the questions may be asked in any format that will result in identifying the user's intended item. In this embodiment the user is first asked for the general category of the item, for example, electronics, apparel, furniture, automobiles, etc. Next, the user identifies what subcategory the product falls within, for example, digital camera, camcorder, CD player, etc. Next, Frucall may ask the user to identify the brand of the item, for example, Sony, Panasonic, JVC, etc. At this point, the user may be asked to identify the particular model of the item, for example, the Sony HDR-HCI camcorder. At each step in the process, Frucall may dynamically build the possible vocabulary by querying the Internet to get the latest information about possibilities within a category, type, or brand. Once the item is identified, Frucall can perform the same price check routine via the Item Pricing Engine 103, as if the bar code had been entered.

Step 136 may employ SOA (Service Oriented Architecture—Web Services) to connect to online shopping and pricing systems. Using SOA makes it possible for the Frucall system, as a computer-implemented system, to act as a user searching these shopping and pricing systems for pricing information. The Core Engine 102 can make API calls to the Item Pricing Interface 103, which provides an abstract object with a common API for supplying the UPC (or other bar code indicia) and obtain pricing information from the Internet based on the UPC. The abstract object may have one implementation for each merchant or price comparison site, as shown in FIG. 2. The Item Pricing Interface 103 can be configured to check different sources depending on the type or category of the product being searched. It can also search the sources and provide the lowest price found. If the item is found, The Core Engine 102 can collect pricing, used/individual listings, customer ratings, recommendations and other related information about the product and store the information in the database 115. This information can be queried by the User Portals 101 to be delivered or communicated to the consumer. Step 138 is an example of this operation, in which the Voice Portal 111 announces the product along with the best new and used price found, and provides choices related to the queried item and retrieves the information based on what the consumer selects.

For example, the item-specific menu may have many actions including, but not limited to: (1) Buy this item; (2) Bookmark this item; (3) Get used and new listings; (4) Get rating and customer reviews; (5) Get recommendations; (6) Leave a voice note on the item. Actions 3 through 5 each result in a query to the Core Engine 102 to retrieve the corresponding information about the item. Action 2 causes an API call to the Core Engine 102 to create a bookmark object and associate the bookmark with the item already stored in the database. Action 6 first does Action 2 automatically, bookmarking the item, and then starts a recording session for a certain period of time over the phone. The consumer's voice, for example, can be communicated from a telephony system and recorded to a file within the system. The path to the file on the storage medium can be communicated to the Core Engine 102 through an API, for example, to be added to previously stored product information. In this manner, the product, its bookmark, and the voice note left by the consumer can be interrelated within the system. Action 1 can be configured to make Frucall complete a sale, i.e., purchasing the product for the consumer from the merchant or online shopping service. This may be accomplished manually or in automated fashion. The Frucall system may keep its own shopping cart with an interface with online payment systems to make it easier for consumers to pay for products purchased through the system.

Since the Frucall system separates data from presentation, and the Core Engine 102 is primarily responsible for manipulating the data, the same data can be accessed through other User Portal 101 types. An SMS or WAP portal interface may vary in User Interface (UI) details and respects, but the logic and flow of the dialog and processing actions can be substantially the same as described above.

The Web Portal 114 may access the same data processed by the Core Engine 102. The Web Portal 114 can provide one or more of the following functions: user registration; user profile updates and preferences; viewing and managing user bookmarks; user search history; user purchase history; search, similar to the way people can search from the voice portal; and/or advertisement functions, among other functions.

Registration is the process that relates a consumer to an e-mail address, an access device phone number, and eventually a credit card or other payment means. If the user has already used the Voice Portal 111, the Frucall system can create temporary user identification for the consumer. Once the consumer enters a phone number on the Web Portal 114, the Frucall system can link search history information and bookmarks made in association with the phone number to the consumer. Because the Frucall system can use a mobile phone as part of the registration process, for example, it can be seen that illegal or unauthorized access to the system can be beneficially resisted.

Upon registration, in various embodiments, the user may supply an e-mail address to the system. The Core Engine 102 can create a registration object with a random validation code. At this point, the status of the consumer may be changed to “Registering.” The Web Portal 114 can retrieve the random validation code and e-mail it to the consumer. The consumer may be required to call back through the Voice Portal 111. The Voice Portal 111, upon receiving a call from the access device of the consumer, can check the status of the consumer for registration. If the status is “Registering,” the Voice Portal 111 goes through a special case for Completing the Registration. The Voice Portal 111 queries the Core Engine 102 for the registration object associated with a phone number of the access device. The Voice Portal 111 may then prompt the consumer to enter a validation code. The Voice Portal 111 can then compare the number or code entered by the consumer with the validation code stored in the registration object. If the validation codes match, the status of the consumer can be changed to “Registered”. In certain embodiments, the user may be permitted to skip this step, allowing the consumer to complete registration at a later time.

Once registration is complete, the consumer's account on the Web Portal 114 can be linked with the access device, and thereby with any past, present or future activity conducted by the consumer on the Voice Portal 111. Therefore, the user can use his or her mobile phone, for example, to check product prices, bookmark items, leave notes on the items, and later review them on a personal computer system via the Web Portal 114, for example.

The registration process may include obtaining the user's ZIP code, or a non-registered user may enter their ZIP code when using Frucall via the Voice Portal 111 or SMS Portal 112. One purpose of obtaining the ZIP code is to enable Frucall to calculate shipping costs to the user's location. Another purpose of obtaining the ZIP code is to allow Frucall to further supply the user with local prices on the desired item. Once the user has supplied his or her ZIP code via any of the User Portals 101, the ZIP code is stored by the Core Engine 102 for all future interactions with the user. Therefore, any time after that when a user calls Frucall the overall location of the user is known. This pre-entered ZIP code may be overridden by the user at any time; for example, when the user is traveling. By having the user's ZIP code, Frucall may locate prices available from stores within the vicinity of the user's ZIP code, either directly from the store's web site on the Internet or indirectly from price aggregators. If there are local prices available, Frucall will present the user with an additional option of obtaining information relating to local prices, deals, and specials. Again, since the User Portals 101 are all interconnected with the Core Engine 102, the user may obtain the information about local prices via any of the User Portals 101, including the Voice Portal 111 and the SMS portal 112.

The Frucall system can employ the Advertisement Engine 105 to deliver targeted advertisements to any of the User Portals 101, such as the Voice Portal 111 or Web Portal 114, for example. Consumer bookmarks and search history can be stored as text, and thus analyzed by online advertisement services such as “Google AdSense” or Amazon ECS/Akamai, or other third-party or built-in engines in real-time or near real-time to match product searches, for example, with certain targeted advertisements. The User Portals 101 decide how to use the advertisement. For example, the Voice Portal 111 plays the advertisement as an audio stream to the user, which could come directly from an audio file or from conversion of text to voice using Text-To-Speech (TTS) technology. The SMS Portal 112 can include the text of the advertisement inside an SMS message. The Web Portal 114 can allocate specific parts of the pages to advertisements, feed consumer bookmarks, search history, purchase history, and/or details of products viewed through the Advertisement Engine 105 to external services such as “Google AdSense”, and then receive advertisements to display.

The Core Engine 102 may also keep track of all consumer actions regarding search and purchase. Over time, this can create a statistical profile of the shopping behavior of each individual consumer, of groups of consumers within certain geographic or demographic areas, and identify general interests in different product categories. The Advertisement Engine 105 can also be configured to retrieve statistical information from the Core Engine 102 to create intelligently targeted strategies for displaying advertisements to consumers.

Since all of the User Portals 101 are interconnected via the Core Engine 102, the user is presented with a unified user interface. An example of this unified user interface allows the user to treat Frucall as a personal “shopping assistant.” When using the Frucall service, the user may place bookmarks and/or voice notes on certain items, as described previously. The user may also enter the price of the item as seen in the store via the Voice Portal 111 or SMS Portal 112. All of these user entries are then saved and compiled by the Core Engine 102, so that when the user next utilizes the Web Portal 114 the results of the user's research is presented. This allows the user, for example, to see the price of items as seen in the store, the user's voice notes on particular items, and the best current online prices of the items. This combination of all of the information supplied by the Voice Portal 111, SMS Portal 112, and/or Web Portal 114 allow the user to make the best decision in order to determine the right item to purchase from the right merchant.

With respect to embodiments of purchasing subsystem embodiments described herein, a Purchasing Queue (“PQ”) may be employed that includes a list of items that consumers have selected to purchase; and a Purchasing Agent (“PA”) may be a person or other entity who can watch the PQ, fetch an item from the PQ, and/or process purchases. The PA may be supplied with an item list that governs the workflow of the PA.

A fetch function of the purchasing system may involve taking an item from the PQ and assigning it to a PA's item list. Once the item is fetched, it can be removed from the PQ. This enables multiple PAs to work on the PQ at the same time. The PA may fetch an item and assign it to its own item list, or a workflow may be established to allow a manager to fetch items and assign them to PA item lists. In addition, an automated system may perform the fetch function and assign items based on the workload of various PAs, for example. Embodiments of the Frucall system may employ a Purchase Processing Portal (PPP) which can include a web-based GUI which is part of the “back-office” operation of the system, allowing PAs to log in and manage the PQ, an item list, perform fetch operations, execute status updates, and/or other functions.

From the time the consumer elects to purchase a product until the item is successfully shipped and is beyond returning, the item may have different Purchase Status (“PS”) values within the Frucall system. The PS can define the workflow of steps that occur until a purchase is fully completed. Examples of PS values include, without limitation, the following status indicators: Being assigned—item is in the PQ; Being processed—item is fetched and will be owned by a PA; Verifying funds—PA makes sure that the consumer user has funds available for a purchase, e.g., put a hold on credit card; Outbound order in progress—PA places the order with provider; Outbound order complete—PA has successfully purchased the item; Item being shipped—PA has verified that the item is shipped by provider; Item received—consumer has received the item.

Like other parts of the system, a backend object can be selected to represent purchase processing, so that the portals can call it via an API. When the consumer selects “buy this item” from any of the portals, for example, the portal can request that the product be added as an item to the PQ. As described above, adding an item to the PQ may result in execution of a fetch function or request. The fetch request can result in an e-mail notification to all PAs who may log into the PPP which is their view or interface into the system. A PA can log into the PPP, view the PQ, fetch the item, and start working on it. The PA may be permitted to see his or her own item list in addition to the main PQ. The PPP can also be configured to allow the PA to change the PS of the item as the order is being processed over time. A PS change can be performed by executing an API call, which results in storing who did what to which item at what time, among other information. The time and status of an order can be communicated to the consumer, such as via the web portal, to let the consumer know what is happening with the order.

In various embodiments, among other functions, the PA may check to make sure the item is available, that the price the consumer has obtained is accurate, and that the consumer has sufficient funds to cover the purchase. The PA can order the item over the Internet, with the end user's shipping address as the shipping address, and Frucall system may be billed for the purchase. Once the purchase is complete, PA can process a charge to the user for the purchase. At each step in the workflow, the PA can update the PS for the order.

In addition to credit cards as payment means, the Frucall system may employ or accept other forms of payment or funds for purchases, such as a prepaid amount of credit or account with the Frucall system, prepaid cards, gift cards, or “PayPal” type purchasing or funds services. Consumers may decide to return purchased products for various reasons, and the Frucall system may be configured to provide a tool or mechanism for facilitating such product returns.

In various embodiments, the web portal 114 or other portals can be configured to permit consumers to provide feedback on specific product purchases, and/or the general operation or use of the Frucall system.

In certain embodiments, each portal is responsible for requesting a PIN to verify consumer identity, and/or intention of the consumer to make a purchase. The Frucall system can be configured such that by entering a PIN in association with purchasing a product, the consumer is agreeing to certain terms of sale.

Another embodiment of the present invention allows a user to set a price alert, or “reminder,” on specific items. Since all of the User Portals 101 are interconnected through the Core Engine 102, the user can set the reminder while he or she is on the phone interacting with the Voice Portal 111, while checking the price of an item, for example. The user could also set a reminder at a different time, while on the Web Portal 114, for example. As mentioned before, all of the User Portals 101 are connected to the Core Engine 102, and as such a reminder may be set by a user utilizing any of the User Portals 101. A reminder allows the user to enter a desired price for a particular item. Frucall stores the item and desired price in its database and checks the price of the item on different backend sources via the Item Pricing Interface 103 until the reminder is removed. Once Frucall finds a merchant offering the item for a price equal to or less than the user's desired price, Frucall will notify the user via at least one of the User Portals 101. For example, Frucall may send an SMS to the user through the SMS Portal 112, call the user via the Voice Portal 111, show an alert in the user's web browser when the user accesses the Web Portal 114, or send the user an email.

As used herein, a “computer” or “computer system” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for receiving, storing and/or processing data for standalone application and/or over a networked medium or media.

Computers and computer systems described herein may include operatively associated computer-readable media such as memory for storing software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, DVD, compact disc, memory stick, ROM (read only memory), RAM (random access memory), PROM (programmable ROM), EEPROM (extended erasable PROM), and/or other like computer-readable media.

In general, computer-readable memory media applied in association with embodiments of the invention described herein may include any memory medium capable of storing instructions executed by a programmable apparatus. Where applicable, method steps described herein may be embodied or executed as instructions stored on a computer-readable memory medium or memory media. These instructions may be software embodied in various programming languages such as C++, C, Java, HTML, and/or a variety of other kinds of software programming languages that may be applied to create instructions in accordance with embodiments of the invention.

It is to be understood that the figures and descriptions of the invention have been simplified to illustrate elements that are relevant for a clear understanding of the invention, while eliminating, for purposes of clarity, other elements. Those of ordinary skill in the art will recognize, however, that these and other elements may be desirable. However, because such elements are well known in the art, and because they do not facilitate a better understanding of the invention, a discussion of such elements is not provided herein. It should be appreciated that the figures are presented for illustrative purposes and not as construction drawings. Omitted details and modifications or alternative embodiments are within the purview of persons of ordinary skill in the art.

It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention.

The examples presented herein are intended to illustrate potential and specific implementations of the invention. It can be appreciated that the examples are intended primarily for purposes of illustration of the invention for those skilled in the art. There may be variations to the diagrams, screen displays, or the operations described herein without departing from the spirit of the invention. For instance, in certain cases, method steps or operations may be performed or executed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described herein.

What is claimed is:

1. A product evaluation system for permitting a consumer to obtain information about an item of interest, the system comprising:
a core engine processor configured for receiving a communication from an access device of the consumer through at least one communication portal, wherein information communicated from the access device includes at least bar code indicia associated with the item of interest, the core engine processor being configured to construct a query for the item of interest based at least in part on the communicated bar code indicia;
an item pricing module operatively associated with the core engine processor, the item pricing module being configured for querying at least one Internet site with the query constructed by the core engine processor to obtain at least price information for the item of interest; and,
an item purchasing module operatively associated with the core engine processor, the item purchasing module being configured for executing one or more purchase orders in association with the item of interest.

2. The system of claim 1, wherein the communication portal includes a voice portal configured for receiving information from a mobile phone access device.

3. A method for registering a consumer to access a system for permitting the consumer to obtain information about an item of interest, the method comprising:
creating in the system a registration object including a random validation code, the registration object being associated with a mobile phone number of the consumer;
e-mailing the random validation code in the registration object to the consumer;
receiving a consumer-supplied random validation code through a voice portal of the system; and,
comparing the consumer-supplied random validation code received through the voice portal to the random validation code included in the registration object.

4. The method of claim 3, further comprising registering the consumer with the system if the consumer-supplied random validation code received through the voice portal matches the random validation code included in the registration object.

5. A product evaluation system for permitting a consumer to obtain information about an item of interest, the system comprising:
a core engine processor configured for receiving a communication from the consumer's mobile phone through a voice portal, wherein information communicated from the mobile phone identifies the item of interest, the core engine processor being configured to construct a query for the item of interest based at least in part on the communicated identifying information;
an item pricing module operatively associated with the core engine processor, the item pricing module being configured for querying at least one Internet site with the query constructed by the core engine processor to obtain at least price information for the item of interest.

6. The system of claim 5, further comprising an item purchasing module operatively associated with the core engine processor, the item purchasing module being configured for executing one or more purchase orders in association with the item of interest.

7. The system of claim 5, wherein the information communicated is bar code indicia associated with the item of interest.

8. The system of claim 5, wherein the information communicated is the answers to a series of questions posed by the core engine.

9. The system of claim 5, further comprising at least one additional communication portal.

10. The system of claim 9, wherein the additional communication portal is an SMS portal.

11. The system of claim 9, wherein the additional communication portal is a web portal.

12. The system of claim 5, wherein the voice portal is accessed by the consumer telephoning said voice portal.

13. The system of claim 5, wherein upon obtaining at least the price information, the core engine is configured to receive additional information from the consumer regarding the item of interest.

14. The system of claim 13, wherein the additional information is a bookmark.

15. The system of claim 13, wherein the additional information is a voice note.

16. The system of claim 13, wherein the additional information is a desired price of the item of interest.

17. The system of claim 16, wherein the item pricing module is configured to monitor the price of the item of interest on at least one Internet site.

18. The system of claim 17, wherein the item pricing module is configured to convey any price information from an Internet site equal to or less than the desired price to the consumer via at least one communication portal.

19. The system of claim 13, wherein the additional information is accessible by the consumer via one of the communication portals.

20. The system of claim 19, wherein the communication portal is a web portal.

21. The system of claim 5, wherein the price information is obtained from an online retail site.

22. The system of claim 5, wherein the price information is obtained from a price aggregator.

23. The system of claim 5, wherein the price information is obtained from a store website, wherein the store is located within the vicinity of the consumer.

24. The system of claim 10, wherein the price information is conveyed to the consumer via the SMS portal.
